(19) United States
(12) Patent Application Publication
(10) Pub. No.: US 2005/0217595 A1
(43) Pub. Date: Oct. 6, 2005

(54) Pet care apparatus and method of thereof

(76) Inventor: Brian Campbell, Beverly, MA (US)

Correspondence Address: Law Offices of Michael Leccese, P.C.;Michael Leccese, Esq., Suite 202, 790 Turnpike St., North Andover, MA, 01845, US

(21) Appl. No.: 10/788,513

(22) Filed: Feb. 27, 2004

(51) Int. Cl. A01K 29/00

(52) U.S. Cl. 119/174

(57) ABSTRACT

An apparatus and method of reminding a person that routine pet care has been completed or need needs to be completed. More particularly the invention relates to a manner in which to provide a reminder to someone that pet care has been accomplished or needs to be accomplished more effectively and efficiently than in the past. The apparatus includes among its essential elements a slender display board having a front face and a rear face; a display graphic being permanently affixed to at least the front face of the display board; a hanger being at least attached to the rear face of the display board wherein the hanger can be used to attach the display board to a substantially vertical surface; a graphic instrument used to deposit erasable marks to at least the front face of the display board; a graphic instrument receptacle attached to the display board wherein the graphic instrument can be removably attached; an eraser element wherein the eraser eradicates the erasable marks deposited by the graphic instrument; and, a plurality of shaped display members having at least a first side and a second side wherein the second side is adapted to be removably affixed to the display board's front face, wherein the shaped members are removably affixed in a position on the display board, each shaped display member able to be removably affixed in any position on the board a plurality of times.

### FIELD

The invention relates generally to a system and method of reminding someone that pet care has been completed or is required to be completed. The apparatus includes among its essential elements; a display board; display board graphics affixed to the board, the graphics depicting at least one of a several time keeping representations; a plurality of movable predetermined shaped display members that temporarily affix to the display board, the movable shaped display members at least in the shape of an animal figure temporally affixing to the display board, the movable shaped member may be moved from one location depicting that a pet care task is required to be completed to another area on the board when the task has been completed, wherein reminding that person or another that the specific tack represented by a predetermined shape has been completed or needs to be completed, the caring for the pet would include but not limited to; walking; feeding; grooming; administering medication and the like.

### BACKGROUND

In the past performing pet care tasks was part of the daily chores one may have performed along with other chores, in one example a person living on a farm would feed the pets as well as performing many other farm chores. Now performing pet care on a routine basis coupled with peoples busy life styles can be a laborious task, pet care givers frequently forget if they performed a specific task or not. Or if in a home with multiple dwellers, pets domiciled in that home each person being jointly responsible to administer pet care, when one person administers the pet care another may be unaware of who did what and when. Care of a pet is made up of a number of routine tasks ranging from feeding the pet to less routine tasks such as administering medication to the pet. Pet care tasks can be routine taking place each day or even multiple times a day, weekly or even monthly. Certainly, pet care can encompass several different routine tasks including but not limited to, feeding, walking, medicating, grooming, allowing the pet to go out of doors, retrieving the pet from the out of doors, and just spending time interacting with the pet. In one illustration it is common that a person may or may not feed a pet in the morning then go off to work or away for a period, later come home only to realize that the person cannot remember if the pet was fed or not. Resulting in the pet not getting fed or getting fed more times than necessary. Or in an other illustration pets being housed in a location that is inhabited with multiple occupants, each occupant taking a joint responsibility for caring for the pet or pets. Each occupant frequently will not know if a task has or has not been completed resulting in the task not getting completed at all or duplication of the task. In one example one person would feed the pet, the pet would eat emptying its dish, them another person jointly responsible for pet care would see the empty dish and feed the pet again resulting in multiple feedings. This in most cases is undesirable, the pet may overeat causing the pet to become ill or in the long term obese and maybe even generally unhealthy. Duplication or non-administering of a task can have catastrophic consequences in some cases such as administering medications to frequently or not frequently enough. Generally, the problem of a person forgetting if they have performed a pet care task or not, or in the alternative whether another person has administer a pet care task can have adverse health effects on the pet.

It is well know in the arts that previous inventors have put forward ways to remind themselves of tasks that need to complete or have to be completed, among those are magnetic perpetual calendars that have magnetic pieces that depict events such as holidays, birthdays, father's day, mother's day. The calendar being magnetic can be adapted to and arranged and used for multiple purposes, multiple months and different years. The calendar including artwork that depicts various items such as objects and animals. It is also well know in the arts that magnetic pieces depicting certain object have been disclosed each object or character showing imagery deposed thereon.

It is also well know in the arts that a small self-contained programmable reminder can be used. Generally this reminder is attached to the household or directly to the pet. This reminder contains audio and visual indicators to alert a pet owner when to administer pet care such as grooming, exercise, feeding and other routine tasks. The self contained timer has electrical circuitry associated with light emitting diodes that remind a person when pet care has been accomplish or when it needs to accomplished.

Yet an other well know art is the magnetic display storyboard. This board uses images of at least one scene where separate temporally affixed magnets having images deposed thereon can be used to tell a story. Images on this story board can take the image of an animal. This type of art is generally used to tell a story and for educational purposes for children.

Other arts used as reminder arts have included a system using a display board and multiple thin magnets with words or indicia printed on them. The reminder boards with words are often used for shopping lists where you would place a word on the display board reminding that person to purchase a specific item.

Typically white boards and chalk boards can also be used to write notes or reminders on. This usually takes time and sometimes can be a chore for one person to understand another's handwriting resulting in miscommunication.

Drawbacks of past designs such as those prior arts will be manifested in complex expensive non-efficient and generally cumbersome to use. Other designs use general perpetual calendars to remind a person of a plurality of tasks including but not limited to pets. Others use complex electronically operated devises that may be broken easily and requires maintenance such as battery replacement.

While many memory reminder devices have been developed to remind a person to perform or remind persons of previously performed tasks. Non of the memory device address the specific problem of reminding a person whether pet care has been completed or needs to be completed in the effective, efficient and convenient way that the present invention accomplishes. The inventor has a novel solution to overcome the problems of reminding someone of pet care and past reminder devices.

### SUMMARY

This invention provides an apparatus and method of determining weather a routine pet care task has been completed or not. More particularly, embodiment of the invention relates to an apparatus and manner in which to use more effectively and efficiently caring for pets. Using embodiments and implementations of this invention will allow the user or multiple users to track and to remind someone when a pet care task has been completed or if one needs to be completed and the time it was completed or requires to be completed. Moreover, embodiments and implementations of this invention will allow the user to record when a pet care task has been accomplished reminding that person or communicating to another person that the pet care task has been completed allowing the routine of pet care to be more efficient and effective. The invention is directed toward reminding a person when a pet care task has been completed or a pet care task needs to be completed. Pet care can take many forms some of which include feeding, walking, exercising, medicating and grooming. These aforementioned tasks are performed on generally a routine basis to keep the pet happy and healthy. Today, most people have busy schedules and frequently need to remind themselves that a task needs to be completed or a task has already been completed. In another scenario where there is multiple persons caring for the pet this invention will provide the necessary pet care communication from one person the next when a pet care task has been or needs to be completed.

Furthermore this Invention will supply the necessary apparatus and method to eliminate the need for someone to remember if they had performed the certain task or if a certain pet care task needs to be completed. Furthermore this invention will allow multiple pet care individuals to perform pet care tasks without the problem of another person duplicating the same task. One way of implementing the invention is when a person performs a pet care task such as feeding a dog in the morning that person feeds the dog then places or moves the a dog shaped figure to the display board in the A.M. portion of the display board. This will remind that person that the dog has been fed or will tell the next person that cares for the dog that the dog has been fed but not necessarily walked.

Implementations further provide a plurality of display members that depict various pet care tasks and a plurality of pets. Embodiments of this invention allow the user to use any combination of pet shaped display members and task display members to remind whether a pet care task has or need to be completed. The user can use and structure use of this invention in a way that suits the need of the user.

It is a further object of this invention to provide an apparatus and method that is simple by design and efficient in method and use.

Yet in a further implantation of this invention allows the user to repeat use by moving the shaped display members on the display board a plurality of times.

In one embodiment a graphic instrument can be used to deposit markings on the display board. These markings can be markings used to aid in the pet care or the markings can be what ever the user wishes to mark. The graphic instrument marks are not permanent marks and can be erased at the discretion of the user. The graphic instrument and eraser can be tethered to the display board to prevent them form getting lost or separated from the display board. Moreover use of this invention aids in pet care so that pet care is more efficient, economical and enjoyable.

Illustrative embodiments and modes of operation of the present invention have been described in this specification. The invention which is intended to be protected herein, however, is not to be construed as limited to the particular embodiments disclosed, since these embodiments are to be regarded as illustrative rather that restrictive. Variations and changes may be made by others without departing from the spirit of this invention. Accordingly, it is expressly intended that all such variations and changes which fall within the spirit and scope of claims be embraced thereby.

### BRIEF DESCRIPTION OF DRAWINGS

Other objects, features, and advantages will occur to those skilled in the art from the following description of an embodiment and the accompanying drawings, in which:

FIG. 1, shows a perspective of the front face of the display board having graphics affixed thereto, a graphic instrument, an eraser and shaped display members able to be removably attached.

FIG. 2, shows a perspective of the front face of the display board having graphics affixed thereto, a graphic instrument, and shaped display members able to be removably attached.

FIG. 3, shows a perspective side view of the slender display board having a hanger.

FIG. 4, shows a perspective rear view of the slender display board having a hanger.

FIG. 5, shows a perspective rear view of the slender display board having a hanger.

FIG. 6, shows a perspective view of a plurality of shaped display members.

### DETAILED DESCRIPTION

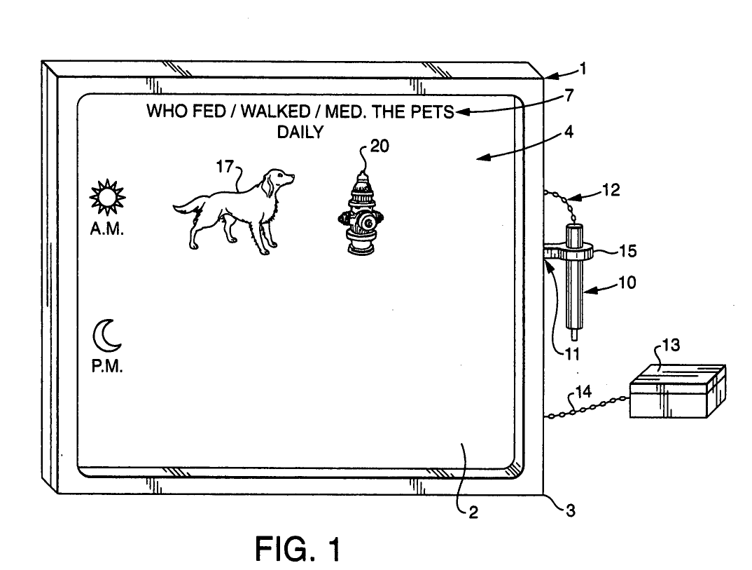

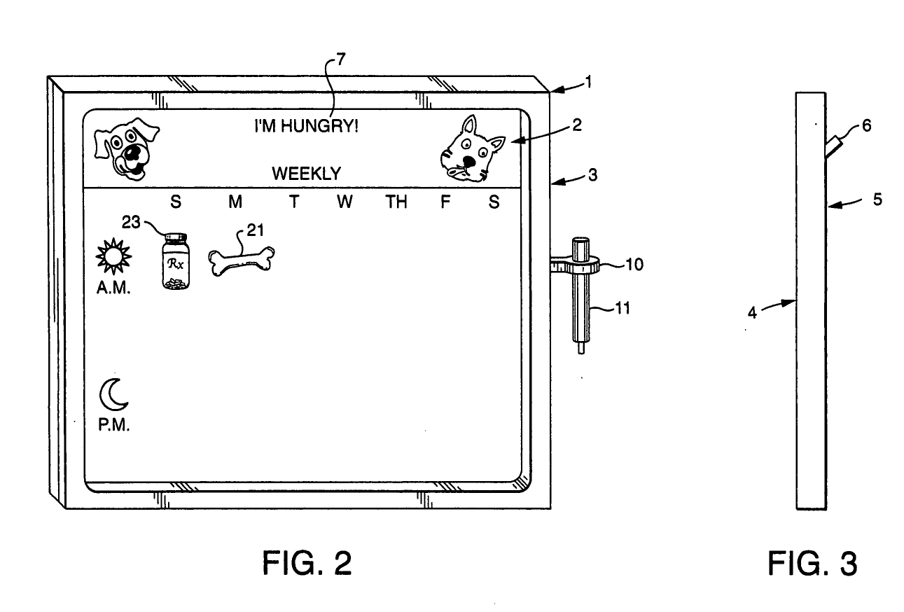

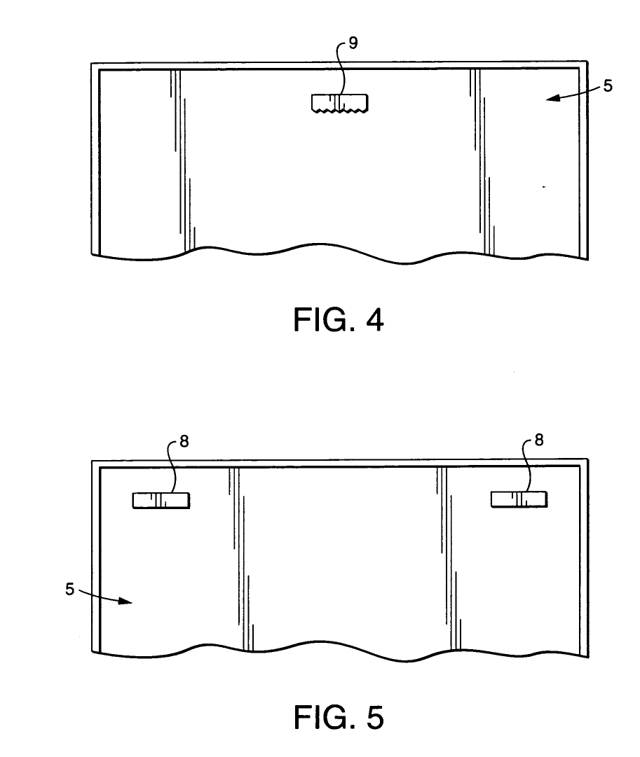

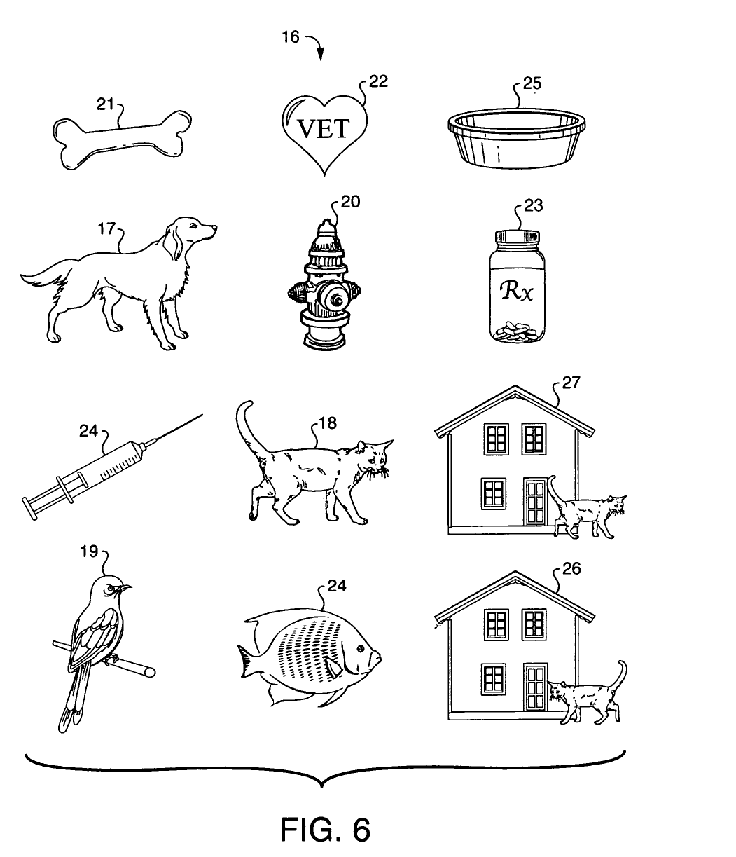

There is shown in FIGS. 1 through 6 an illustrated pet care apparatus. The pet care reminder apparatus 1 comprises a slender display board 2 and an optional frame 3, the display board 2 having a front face 4 and a rear face 5. The pet care apparatus 1 also includes hanger 6 being at least attached to the rear face 5 of the display board 1 or frame 3 wherein the hanger 6 can be used to attach the display board 1 to a substantially vertical surface. Such examples of display board hangers may include magnets 8 attached to the display board so that the display board 1 can be attached to a surface that magnets 8 typically adhere to, or a picture type hook or hanger 9 used to hang the display board 1 on a wall. In one embodiment the pet care apparatus has a graphic instrument 10 used to deposit erasable marks to at least to the front face 4 of the display board. In one illustration the apparatus includes a display graphic 7 being permanently affixed to at least the front face of the display board 4. When the apparatus uses a graphic instrument 10 the apparatus may contain a graphic instrument receptacle 15 attached 11 to the display board 1 wherein the graphic instrument 10 can be removably attached 15, the graphic instrument 10 may be tethered 12 to the display board 1. Also in an illustration an eraser element 13 can be tethered 14 to the display board 1 wherein the eraser eradicates the erasable marks deposited by the graphic instrument 10. The apparatus includes a plurality of shaped display members 16 having at least a first side and a second side wherein the second side is adapted to be removably affixed to the display board's front face 4. In a single illustration the shaped display members are magnets or have magnets attached thereto and the display board contains a material that a magnet would typically adhere to. The shaped members are removably affixed in a position on the display board, each shaped display member able to be removably affixed in any position on the board a plurality of times. The shaped display member takes the shape of many different figures, some of which can be a dog 17, a cat 18, a bird 19, a fire hydrant 20, a dog bone 21, a heart 22, a medication pill container 23, a fish 24, a pets food dish 25, a syringe 24, a cat running into a building 26, a cat running out of a building 27, a dog running into a building and a dog running out of a building. The shaped display member not only can take the shape of a many different figures but may also have a printed image on it. The shaped display member may have a printed image deposited on it, preferably placed on the first side of the shaped display member. The image can be an image of the users choice such as but not limited to a photograph of a family pet, a sketch image of a pet, a digital photograph of a pet, a photo of an object such as fire hydrant and many other images.

1. A pet care system comprising;
a slender display board having a front face and a rear face,
a display graphic being permanently affixed to at least the front face of the display board,
a hanger being at least attached to the rear face of the display board wherein the hanger can be used to attach the display board to a substantially vertical surface,
a graphic instrument used to deposit erasable marks to at least the front face of the display board,
a graphic instrument receptacle attached to the display board wherein the graphic instrument can be removably attached,
an eraser element wherein the eraser eradicates the erasable marks deposited by the graphic instrument; and,
a plurality of shaped display members having at least a first side and a second side wherein the second side is adapted to be removably affixed to the display board's front face, wherein the shaped members are removably affixed in a position on the display board, each shaped display member able to be removably affixed in any position on the board a plurality of times.

2. The pet care system of claim 1 wherein the display graphics shows at least “A.M” and “P.M.”

3. The pet care system of claim 1 wherein the display graphics shows at least “A.M” and “P.M.” and days of the week.

4. The pet care system of claim 1 wherein the display graphic is a predetermined color.

5. The pet care system of claim 1 wherein the display board is a predetermined color.

6. The pet care system of claim 1 wherein the graphic instrument receptacle is a, clasp, clip, hook, hanger, suction cup, magnet or the like.

7. The pet care system of claim 1 wherein the hanger is a clasp, clip, hook, hanger, suction cup, magnet or the like.

8. The pet care system of claim 1 wherein the shaped member's second side being removably affixed is a, clasp, clip, hook, hanger, suction cup, magnet or the like.

9. The pet care system of claim 1 wherein the graphic instrument is tethered to the display board.

10. The pet care system of claim 1 wherein the display board is housed in a frame.

11. The pet care system of claim 1 wherein the erasure is tethered to the display board.

12. The pet care system of claim 1 wherein the shaped display member has an image of a pet deposited thereto.

13. The pet care system of claim 1 wherein the shaped display member is in the shape of a dog.

14. The pet care system of claim 1 wherein the shaped display member is in the shape of a cat.

15. The pet care system of claim 1 wherein the shaped display member is in the shape of a bird.

16. The pet care system of claim 1 wherein the shaped display member is in the shape of a fire hydrant.

17. The pet care system of claim 1 wherein the shaped display member is in the shape of a dog bone.

18. The pet care system of claim 1 wherein the shaped display member is in the shape of a heart.

19. The pet care system of claim 1 wherein the shaped display member is in the shape of a medication pill container.

20. The pet care system of claim 1 wherein the shaped display member is in the shape of a fish.

21. The pet care system of claim 1 wherein the shaped display member is in the shape of a pet food dish.

22. The pet care system of claim 1 wherein the shaped display member is in the shape of a syringe

23. The pet care system of claim 1 wherein the shaped display member is in the shape of a cat running into a building.

24. The pet care system of claim 1 wherein the shaped display member is in the shape of a dog running into a building.

25. The pet care system of claim 1 wherein the shaped display member is in the shape of a cat running out of building.

26. The pet care system of claim 1 wherein the shaped display member is in the shape of a dog running out of a building.

27. A method recording when pet care has been or needs to be complete comprising:
using a slender display board having a front face and a rear face, the front face having a display graphic permeably affixed thereto,
affixing the display board on a substantially vertical surface, the display board having a front face and a rear face, the rear face having a vertical surface attachment means,
affixing a permanent display graphic on the display board,
placing at least one of a plurality of shaped display members having at least a first side and a second side wherein the second side is adapted to be removably affixed to at least the display board's front face,
performing pet care task,
moving the shaped display member from one removably affixed position on the display board to another removably affixed position on the display board when a pet care task is complete or needs to be completed, wherein the shaped members are removably attached to the display board in a position on the display board,
removing and placing the shaped display in another position as pet care tasks are completed or needs to be completed, each shaped display representing a performed pet care task, each display shape moving and placing a plurality of times to display pet care tasks,
marking on the board using a graphic instrument making temporary markings; and,
erasing the temporary markings using an eraser.
